(19) United States
(12) Patent Application Publication
(10) Pub. No.: US 2015/0095458 A1
(43) Pub. Date: Apr. 2, 2015

(54) METHODS AND SYSTEMS FOR PROVIDING A SEAMLESS TRANSITION OF DOCUMENTS BETWEEN CLIENT TYPES

(71) Applicant: Xerox Corporation, Norwalk, CT (US)

(72) Inventors: Matthew DeRoller, Webster, NY (US); Emil Victor Rainero, Webster, NY (US)

(73) Assignee: Xerox Corporation, Norwalk, CT (US)

(21) Appl. No.: 14/039,616

(22) Filed: Sep. 27, 2013

(51) Int. Cl. H04L 29/06

(52) U.S. Cl. CPC H04L 67/42
USPC 709/219

(57) ABSTRACT

A method of synchronizing a document across a plurality of client computing devices may include receiving a first document comprising one or more pages, reformatting the first document so that each page of the received first document is a separate second document, associating a metadata file with each second document, receiving one or more access requests for one or more of the second documents from a user, updating one or more of the metadata files to reflect the one or more access requests, identifying a plurality of client computing devices associated with the user to which the document is to be synchronized, and transmitting at least a portion of the second documents to each of the identified client computing devices.

### BACKGROUND

Certain companies and individuals look to reduce printing in an effort to reduce direct document printing costs and help the environment. This has led to a shift from paper-centric processes to process-centric workflows. However, certain functionality present with paper-centric processes, such as the ability to annotate documents, is difficult to replicate in process-centric workflows.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. As used herein, the term “comprising” means “including, but not limited to.”

In an embodiment, a method of synchronizing a document across a plurality of client computing devices may include receiving a first document comprising one or more pages, reformatting the first document so that each page of the received first document is a separate second document, associating a metadata file with each second document, receiving one or more access requests for one or more of the second documents from a user, updating one or more of the metadata files to reflect the one or more access requests, identifying a plurality of client computing devices associated with the user to which the document is to be synchronized, and transmitting at least a portion of the second documents to each of the identified client computing devices.

In an embodiment, a method of synchronizing a document across a plurality of client computing devices may include receiving a first document comprising one or more pages, reformatting the first document so that each page of the received first document is a separate second document, associating each second document with a metadata file, receiving one or more access requests for the one or more second documents, updating one or more of the metadata files to reflect the one or more access requests, identifying a plurality of client computing devices associated with a plurality of users to which one or more of the second documents are to be synchronized, and transmitting one or more of the second documents to each of the identified client computing devices.

In an embodiment, a system of synchronizing a document across a plurality of client computing devices may include a computing device and a computer-readable storage medium. The computer-readable storage medium may include one or more programming instructions that, when executed, cause the computing device to receive a first document comprising one or more pages, reformat the document so that each page of the received document is a separate second document, associate each second document with a metadata file, receive one or more access requests for one or more of the second documents document from a user, update one or more of the metadata files to reflect the one or more access requests, identify a plurality of client computing devices associated with the user to which one or more of the second documents is to be synchronized, and transmit one or more of the second documents to each of the identified client computing devices.

In an embodiment, a system of synchronizing a document across a plurality of client computing devices may include a computing device and a computer-readable storage medium. The computer-readable storage medium may include one or more programming instructions that, when executed, cause the computing device to receive a first document comprising one or more pages, reformat the first document so that each page of the received first document is a separate second document, associated each second document with a metadata file, receive one or more access requests for one or more of the second documents, update one or more of the metadata files to reflect the one or more access requests, identify a plurality of client computing devices associated with a plurality of users to which one or more of the second documents is to be synchronized, and transmit one or more of the second documents to each of the identified client computing devices.

In an embodiment, a method of synchronizing a document across a plurality of client computing devices may include sending a document by one of a plurality of client computing devices associated with a user to a digital alternative computing device, receiving the document by the other client computing devices, performing, by one or more of the client computing devices, one or more functions on the document to create a modified document, and receiving, by each of the client computing devices, at least a portion of the modified document.

### BRIEF DESCRIPTION OF THE DRAWINGS

FIG. 1 illustrates an example of a production environment according to an embodiment.

FIG. 2 illustrates a flow chart of an example method of determining a cell configuration according to an embodiment.

FIG. 3 illustrates a block diagram of example hardware that may be used to contain or implement program instructions according to an embodiment.

### DETAILED DESCRIPTION

The following terms shall have, for purposes of this application, the respective meanings set forth below:

A “computing device” refers to a device that includes a processor and non-transitory, computer-readable memory. The memory may contain programming instructions that, when executed by the processor, cause the computing device to perform one or more operations according to the programming instructions. Examples of computing devices include personal computers, servers, mainframes, gaming systems, televisions, and portable electronic devices such as smartphones, personal digital assistants, cameras, tablet computers, laptop computers, media players and the like.

A “document” refers to an electronic record or file having content. Examples of documents may include word processing files, spreadsheet files, PDFs, slide presentations and/or the like.

The described system offers document editors and viewers an alternative to printing documents that provides similar flexibility to document access, modification and viewing as hard copy documents. Documents may be created, viewed, modified and/or otherwise accessed from one client device and synchronized to one or more other client devices to provide for the seamless transition of documents between client devices.

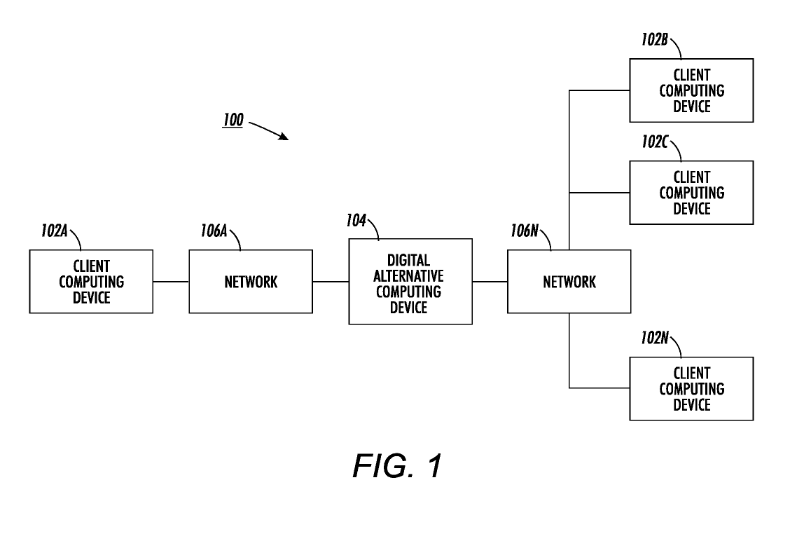

FIG. 1 illustrates an example system for providing a digital alternative to printing documents according to an embodiment. As illustrated by FIG. 1, a digital alternative system 100 may include one or more client computing devices 102a-N and a digital alternative computing device 104 in communication with one or more of the client computing devices 102a-N via one or more communication networks 106a-N.

A client computing device may be a computing device associated with a user of a print alternative service. Examples of client computing devices 102a-N may include, without limitation, a laptop computer, a desktop computer, a tablet, a mobile device and/or the like.

In an embodiment, a digital alternative computing device may be a computing device that is configured to synchronize digital content across client computing devices. Examples of a digital alternative computing device 104 may include, without limitation, a server, a mainframe or other computing device.

In an embodiment, a communication network 106a-N may be a local area network (LAN), a wide area network (WAN), a mobile or cellular communication network, an extranet, an intranet, the Internet and/or the like. In an embodiment, a communication network 106a-N may provide communication capability between one or more client computing devices 102a-N and a digital alternative computing device 104.

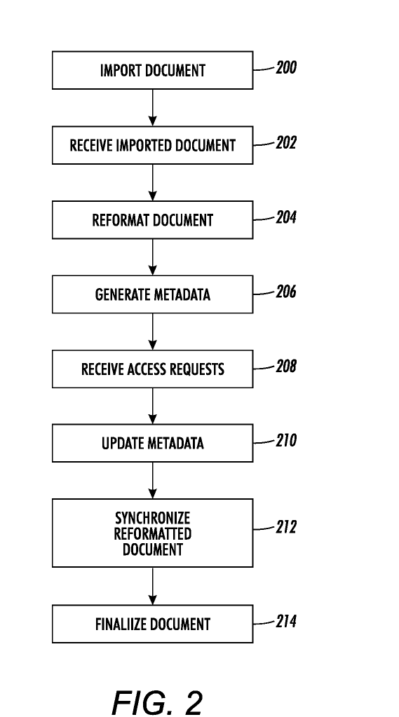

FIG. 2 illustrates a flow chart of an example method of providing a seamless transition of a document between client types according to an embodiment. As illustrated by FIG. 2, a user may import 200 a document into a digital alternative system. A user may import 200 a document into a digital alternative system by indicating that the document should be saved to the digital alternative system, printed to the digital alternative system and/or the like. An imported document may be of any suitable format including, without limitation, a word processing document, a slide presentation, a spreadsheet, free text, images, a PDF document and/or the like.

In an embodiment, an imported document may be associated with a particular user via one or more credentials. For example, a user may present one or more credentials, such as, for example, a username and a password, to access a digital alternative system. The system may associate the credentials with one or more documents in order to synchronize the document across multiple client devices of the user.

A digital alternative system may receive 202 an imported document, and may reformat 204 the received document. Reformatting 204 a received document may involve converting the document into multiple PDF documents. In an embodiment, a received document may be converted into a number PDF documents equal to the number of pages in the received document. For example, if a 20 page word processing document is received 202, a digital alternative system may convert 204 the document into 20 separate PDF documents.

In an embodiment, the system may generate 206 metadata associated with the reformatted document. The metadata may include information about the document such as, for example, the document name, tags, date of creation and/or the like. Metadata may include an indication of one or more edits performed on the document. For example, metadata may include an indication that notes were added to the document, that the document was highlighted, that a signature was added to the document and/or the like. The metadata may include a timestamp associated with one or more of the edits, an indication of the user who made one or more edits and/or the like. In an embodiment, metadata for a document may be stored in a database or other storage medium. According to various embodiments, annotations to a document may be stored separately from other metadata for a document. For example, one or more annotations to a document may be stored as serialized collections.

Referring back to FIG. 2, the system may receive 208 one or more access requests corresponding to one or more documents. An access request may involve the performance of one or more functions on a document. Example functions may include, without limitation, reading, viewing, saving, annotating, sharing, editing, modifying and/or the like. For example, a user may annotate a document and may save the annotations. In an embodiment, a document may be accessible to multiple system users, not only the user who created or imported the document. For example, a user may import a document to be reviewed by a team of users. As such, access requests may be received from different users. For example, the team members may each annotate the document, and the annotations may be saved and accessible to each of the other team members. In an embodiment, the system may update 210 the metadata associated with the document to reflect any updates, changes or modifications to the document.

A digital alternative system may synchronize 212 the reformatted document across one or more client computing devices. A digital alternative system may store an indication of one or more client computing devices associated with one or more users. In an embodiment, a user may register one or more of the user's client computing devices with the digital alternative system. In an embodiment, a user may register one or more client computing devices using one or more of their company or organization credentials. For example, a user may use their company email address and/or network login credentials to register one or more client devices. This process may associate a user's client computing device with the right company or organization, and may establish or set up correct connection channels.

A digital alternative system may synchronize 212 the reformatted document across one or more client computing devices of the user who imported the document into the system and/or one or more other users. In an embodiment, the system may synchronize 212 a document in response to receiving an indication from a user. For example, a user may edit a document on the user's laptop computing device. When the user has finished editing the document, the user may indicate that the document is ready to synchronize by pressing a button, making a selection and/or otherwise providing an indication. In response to receiving the indication, the system may cause the document to be synchronized with the other client computing devices of the user.

In an alternate embodiment, the system may automatically synchronize 212 a document. For example, when a user exits or closes a document on one client device, the system may synchronize the documents with the user's other client computing devices.

In an embodiment, synchronizing 212 a document with another client device may involve the system transmitting the document to one or more client computing devices. If the document has yet to be synchronized with a client computing device, the system may transmit the entire document to the client computing device. For example, a user may begin working on a document on the user's laptop computer, but the user may also have a mobile phone and a tablet computer. The document may be synchronized 212 across the user's mobile phone and tablet. If the document has not previously been synchronized, then the system may download or otherwise transmit the entire document to the mobile phone and/or the tablet.

In an embodiment, synchronizing 212 a document with another client device may involve the system transmitting a portion of the document to one or more client computing devices. For example, a system may only transmit an updated portion of a document that has not previously been synchronized across client computing devices. For instance, a user may edit a document on the user's tablet computer. The original version of the document may have already been synchronized across the user's laptop computer and mobile phone, so the system may only download the updated portions of the document to these computing devices. In an embodiment, the system may use the metadata to determine which portions of a document have been updated. The system may download at least a portion of the metadata to one or more client computing devices as part of the synchronization process. As such, a user may begin work on one client computing device and may continue on a different client computing device.

In an embodiment, the system may synchronize 212 a document across client devices for each user who has privileges to access the document. For example, a team of four members may have permissions to access, read, modify and save a document, and each member may have a laptop computer and a mobile phone. When modifications are made by one team member, the modifications may be synchronized across each team member's laptop and mobile phone. The system may notify a user when an updated document is available. For example, the system may display a notification, may send a user a message such as via email or text message and/or the like.

In an embodiment, when a user access the digital alternative system from another of the user's client computing devices, the user may be able to access the most recent version of the document as previously accessed, modified and/or the like on a different client computing device. For example, a user may edit a document on the user's laptop and may be able to access the edited document on the user's tablet.

According to various embodiments, once a user or users are through accessing a document, the document may be finalized 214. The system may receive an indication from one or more users that a document is to be finalized 214. For example, a user may make a selection or otherwise provide input indicating that a document is to be finalized 214. Finalizing a document may mean that the document is no longer modifiable via the digital alternative system. When the system receives an indication that a document is to be finalized 214, the system may convert the document. For example, the system may convert the document from numerous single page files into one multi-page file. The system may provide one or more users with a copy of the finalized document. For example, the system may email or otherwise send a copy of the finalized document to one or more users. As another example, the document may be shared with one or more users in the digital alternative system.

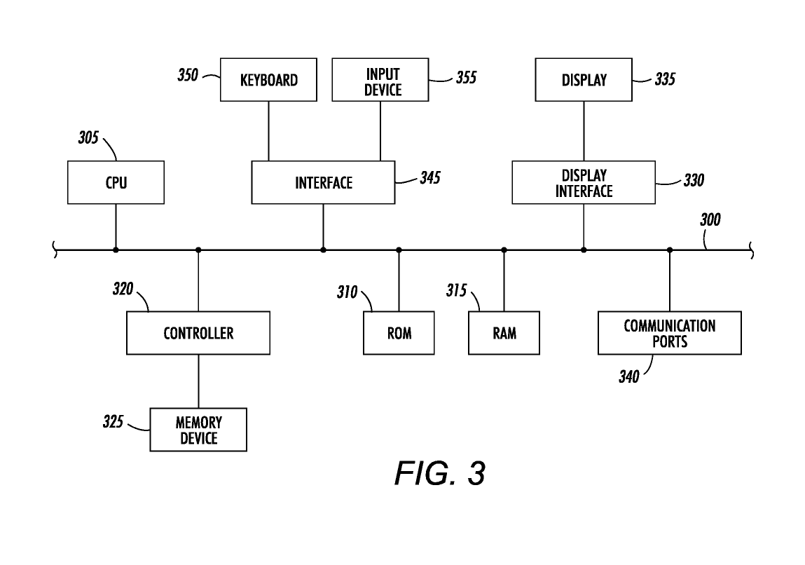

FIG. 3 depicts a block diagram of hardware that may be used to contain or implement program instructions. A bus 300 serves as the main information highway interconnecting the other illustrated components of the hardware. CPU 305 is the central processing unit of the system, performing calculations and logic operations required to execute a program. CPU 305, alone or in conjunction with one or more of the other elements disclosed in FIG. 3, is an example of a production device, computing device or processor as such terms are used within this disclosure. Read only memory (ROM) 310 and random access memory (RAM) 315 constitute examples of non-transitory computer-readable storage media.

A controller 320 interfaces with one or more optional non-transitory computer-readable storage media 325 to the system bus 300. These storage media 325 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 310 and/or the RAM 315. Optionally, the program instructions may be stored on a tangible non-transitory computer-readable medium such as a compact disk, a digital disk, flash memory, a memory card, a USB drive, an optical disc storage medium, such as a Blu-ray™ disc, and/or other recording medium.

An optional display interface 330 may permit information from the bus 300 to be displayed on the display 335 in audio, visual, graphic or alphanumeric format. Communication with external devices, such as a printing device, may occur using various communication ports 340. A communication port 340 may be attached to a communications network, such as the Internet or an intranet.

The hardware may also include an interface 345 which allows for receipt of data from input devices such as a keyboard 350 or other input device 355 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

What is claimed is:

1. A method of synchronizing a document across a plurality of client computing devices, the method comprising:
receiving a first document comprising one or more pages;
reformatting the first document so that each page of the received first document is a separate second document;
associating a metadata file with each second document;
receiving one or more access requests for one or more of the second documents from a user;
updating one or more of the metadata files to reflect the one or more access requests;
identifying a plurality of client computing devices associated with the user to which the document is to be synchronized; and
transmitting at least a portion of the second documents to each of the identified client computing devices.

2. The method of claim 1, wherein each metadata file comprises one or more of the following:
a title of the first document;
a date on which the first document was created;
one or more edits made to the second documents; and
a timestamp associated with the one or more edits.

3. The method of claim 1, wherein identifying a plurality of client computing devices associated with the user comprises identifying a plurality of client devices registered with a digital alternative solution system.

4. The method of claim 1, wherein transmitting at least a portion of the second documents to each of the identified client computing devices comprises:
identifying one or more of the second documents that have been modified over a time period; and
downloading the identified second documents to each of the identified client computing devices.

5. The method of claim 1, further comprising:
receiving an indication that the second documents are to be finalized;
converting the second documents into a single document that comprises each second document; and
providing the converted document to the user.

6. A method of synchronizing a document across a plurality of client computing devices, the method comprising:
receiving a first document comprising one or more pages;
reformatting the first document so that each page of the received first document is a separate second document;
associating each second document with a metadata file;
receiving one or more access requests for the one or more second documents;
updating one or more of the metadata files to reflect the one or more access requests;
identifying a plurality of client computing devices associated with a plurality of users to which one or more of the second documents are to be synchronized; and
transmitting one or more of the second documents to each of the identified client computing devices.

7. The method of claim 6, wherein each metadata file comprises one or more of the following:
a title of the document;
a date on which the document was created;
one or more edits made to the document; and
a timestamp associated with the one or more edits.

8. The method of claim 6, wherein identifying a plurality of client computing devices comprises:
identifying the plurality of users, wherein each user in the plurality of users has permission to access the one or more second documents; and
for each user, identifying a plurality of client devices registered with a digital alternative solution system.

9. The method of claim 6, wherein transmitting one or more of the second documents to each of the identified client computing devices comprises:
identifying one or more of the second documents that have been modified over a time period; and
downloading the identified second documents to each of the identified client computing devices.

10. The method of claim 6, further comprising:
receiving an indication that the second documents are to be finalized;
converting the second documents into a single document that comprises each second document; and
providing the converted document to one or more of the users.

11. A system of synchronizing a document across a plurality of client computing devices, the system comprising:
a computing device; and
a computer-readable storage medium comprising one or more programming instructions that, when executed, cause the computing device to:
receive a first document comprising one or more pages,
reformat the document so that each page of the received document is a separate second document,
associate each second document with a metadata file,
receive one or more access requests for one or more of the second documents document from a user,
update one or more of the metadata files to reflect the one or more access requests,
identify a plurality of client computing devices associated with the user to which one or more of the second documents is to be synchronized, and
transmit one or more of the second documents to each of the identified client computing devices.

12. The system of claim 11, wherein each metadata file comprises one or more of the following:
a title of the first document;
a date on which the first document was created;
one or more edits made to one or more of the second documents; and
a timestamp associated with the one or more edits.

13. The system of claim 11, wherein the one or more programming instructions that, when executed, cause the computing device to identify a plurality of client computing devices associated with the user comprise one or more programming instructions that, when executed, cause the computing device to identify a plurality of client devices registered with a digital alternative solution system.

14. The system of claim 11, wherein the one or more programming instructions that, when executed, cause the computing device to transmit one or more of the second documents to each of the identified client computing devices comprise one or more programming instructions that, when executed, cause the computing device to:
identify one or more of the second documents that have been modified over a time period; and
download the identified second documents to each of the identified client computing devices.

15. The system of claim 11, wherein the computer-readable storage medium further comprises one or more programming instructions that, when executed, cause the computing device to:
receive an indication that the second documents are to be finalized;
convert the second documents into a single document that comprises each second document; and
provide the converted document to the user.

16. A system of synchronizing a document across a plurality of client computing devices, the system comprising:
a computing device; and
a computer-readable storage medium comprising one or more programming instructions that, when executed, cause the computing device to:
receive a first document comprising one or more pages,
reformat the first document so that each page of the received first document is a separate second document,
associated each second document with a metadata file,
receive one or more access requests for one or more of the second documents,
update one or more of the metadata files to reflect the one or more access requests,
identify a plurality of client computing devices associated with a plurality of users to which one or more of the second documents is to be synchronized, and
transmit one or more of the second documents to each of the identified client computing devices.

17. The system of claim 16, wherein each metadata file comprises one or more of the following:
a title of the first document;
a date on which the first document was created;
one or more edits made to one or more of the second documents; and
a timestamp associated with the one or more edits.

18. The system of claim 16, wherein the one or more programming instructions that, when executed, cause the computing device to identify a plurality of client computing devices comprise one or more programming instructions that, when executed, cause the computing device to:
identify the plurality of users, wherein each user in the plurality of users has permission to access the second documents; and
for each user, identify a plurality of client devices registered with a digital alternative solution system.

19. The system of claim 16, wherein the one or more programming instructions that, when executed, cause the computing device to transmit the second documents to each of the identified client computing devices comprise one or more programming instructions that, when executed, cause the computing device to:
identify one or more second documents that have been modified over a time period; and
download the identified second documents to each of the identified client computing devices.

20. The system of claim 16, wherein the computer-readable storage medium further comprises one or more programming instructions that, when executed, cause the computing device to:
receive an indication that the second documents are to be finalized;
convert the second documents into a single document that comprises each second document; and
provide the converted document to one or more of the users.

21. A method of synchronizing a document across a plurality of client computing devices, the method comprising:
sending a document by one of a plurality of client computing devices associated with a user to a digital alternative computing device;
receiving the document by the other client computing devices;
performing, by one or more of the client computing devices, one or more functions on the document to create a modified document; and
receiving, by each of the client computing devices, at least a portion of the modified document.

22. The method of claim 21, wherein receiving at least a portion of the modified document comprises receiving a portion of the modified document that has been modified since the document was previously received by the corresponding client computing device.

23. The method of claim 21, further comprising:
sending, by one of the client computing devices, an indication that the document is to be finalized; and
receiving, by each of the client computing devices, a finalized version of the document.
